(19) United States
(12) Patent Application Publication
(10) Pub. No.: US 2017/0171334 A1
(43) Pub. Date: Jun. 15, 2017

(54) Single-account multiple-preference recommendation method for video website and electronic device

(71) Applicants: LE HOLDINGS (BEIJING) CO., LTD., Beijing (CN); LE SHI INTERNET INFORMATION & TECHNOLOGY CORP., BEIJING, Beijing (CN)

(72) Inventor: Xiaolin LI, Beijing (CN)

(73) Assignees: LE HOLDINGS (BEIJING) CO., LTD., Beijing (CN); LE SHI INTERNET INFORMATION & TECHNOLOGY CORP., BEIJING, Beijing (CN)

(21) Appl. No.: 15/243,139

(22) Filed: Aug. 22, 2016

Related U.S. Application Data
(63) Continuation of application No. PCT/CN2016/089555, filed on Jul. 10, 2016.

(30) Foreign Application Priority Data
Dec. 14, 2015 (CN) 201510924401.0

(51) Int. Cl. H04L 29/08; H04L 29/06

(52) U.S. Cl. CPC H04L 67/26; H04L 67/02; H04L 65/60; H04L 67/306; H04L 67/24; H04L 67/22; H04N 21/25

(57) ABSTRACT

Embodiments of the present disclosure relate to video recommendation, and disclose a single-account multiple-preference recommendation method for a video website and an electronic device, where the single-account multiple-preference recommendation method for a video website includes: detecting an account which a user logs into, and displaying one or more associated sub-accounts of the account; detecting which sub-account the user selects from the one or more associated sub-accounts; determining, according to the selected sub-account, a recommended candidate video associated with the sub-account; and selecting a video from the recommended candidate video and pushing the selected video to the user. The single-account multiple-preference recommendation method for a video website provided in the embodiments of the present disclosure greatly improves user experience, and resolves the problem of inaccurate recommendation for single account and multiple users.

### CROSS-REFERENCE TO RELATED APPLICATIONS

The present disclosure a continuation of international application No. PCT/CN2016/089555, filed on Jul. 10, 2016, which is based upon and claims priority to Chinese Patent Application No. 201510924401.0, filed on Dec. 14, 2015, the entire contents of which are incorporated herein by reference.

### TECHNICAL FIELD

Embodiments of the present disclosure relate to video recommendation, and more particularly, to a single-account multiple-preference recommendation method for a video website and a single-account multiple-preference recommendation apparatus for a video website.

### BACKGROUND

Nowadays, many video portal sites provide a preference recommendation capability for accounts. After a user logs into an account, videos that the user may be fond of are recommended to the user according to preferences of the user. However, if more than one person share an account, for example, family members share an account, preferences vary from person to person. Therefore, the preference recommendation capability may work for only a person logged in to the account, but not work for others, which greatly degrades user experience and causes inaccurate recommendation for single account and multiple users.

### SUMMARY

An objective of embodiments of the present invention is to provide a single-account multiple-preference recommendation method for a video website and an electronic device, which. The method greatly improve user experience, and resolve the problem of inaccurate recommendation for single account and multiple users.

According to the first aspect, an embodiment of the present disclosure provides a single-account multiple-preference recommendation method for a video website, where the recommendation method includes: detecting an account which a user logs into, and displaying one or more associated sub-accounts of the account; detecting an sub-account the user selects from the one or more associated sub-accounts; determining, according to the selected sub-account, at least one recommended candidate video associated with the sub-account; and selecting a video from the at least one recommended candidate video and pushing the selected video to the user.

According to the second aspect, an embodiment of the present disclosure further provides a non-volatile computer memory, which stores computer executable instructions, where the computer executable instructions are used to execute any foregoing single-account multiple-preference recommendation method for a video website of this disclosure.

According to the third aspect, an embodiment of the present disclosure further provides an electronic device, including: at least one processor; and a memory communicably connected with the at least one processor for storing instructions executable by the at least one processor, where execution of the instructions by the at least one processor causes the at least one processor to execute any foregoing single-account multiple-preference recommendation method for a video web site of the present disclosure

### BRIEF DESCRIPTION OF THE DRAWINGS

The accompanying drawings are intended to provide a further understanding of embodiments of the present disclosure, and constitute a part of this specification. The drawings are intended to be used in combination with specific implementation manners below to explain the embodiments of the present disclosure, but not to limit the embodiments of the present disclosure. In the accompanying drawings:

FIG. 1 is a flowchart illustrating a single-account multiple-preference recommendation method according to an embodiment of the present disclosure;

FIG. 2 is a flowchart illustrating determining a recommended candidate video for each sub-account;

FIG. 3 is a schematic structural diagram illustrating a single-account multiple-preference recommendation apparatus according to an embodiment of the present disclosure; and

FIG. 4 is a schematic structural diagram of hardware of an electronic device for executing a single-account multiple-preference recommendation method according to an embodiment the present disclosure.

### DETAILED DESCRIPTION

Specific implementation manners of the present disclosure are described in detail below with reference to the accompanying drawings. It is to be understood that, the specific implementation manners described herein are intended only to describe and explain embodiments of the present disclosure, but not to limit the embodiments of the present invention.

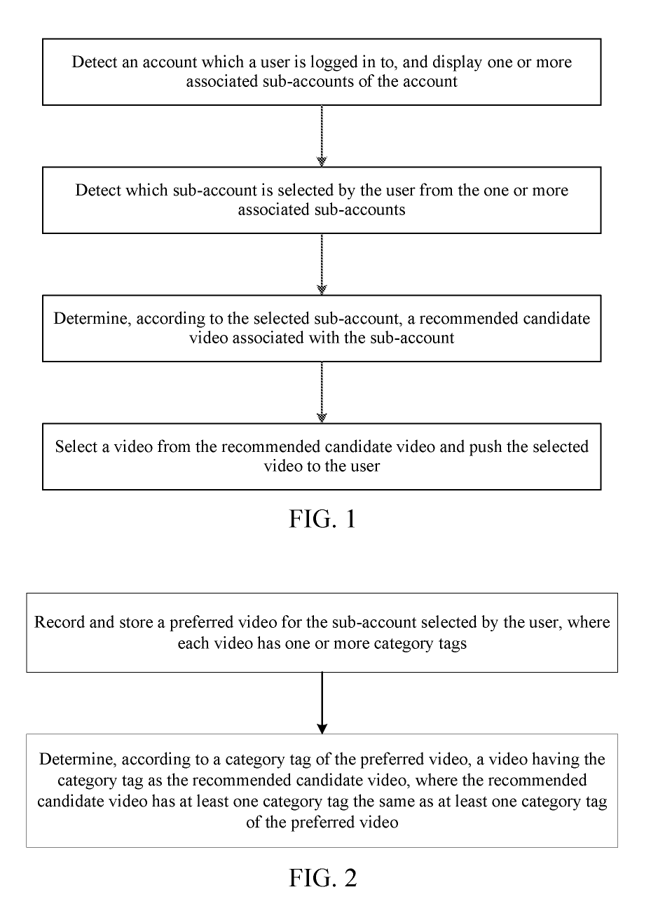

FIG. 1 is a flowchart illustrating a single-account multiple-preference recommendation method according to an embodiment of the present disclosure. As illustrated in FIG. 1, a single-account multiple-preference recommendation method for a video website includes: detecting an account which a user logs into, and displaying one or more associated sub-accounts of the account; detecting a sub-account the user selects from the one or more associated sub-accounts; determining, according to the selected sub-account, at least one recommended candidate video associated with the sub-account; and selecting at least one video from the at least one recommended candidate video and pushing the selected video to the user. The selecting a video from the at least one recommended candidate video and pushing the selected video to the user includes: determining a recommendation level of the recommended candidate video, and preferentially pushing a recommended candidate video with a higher recommendation level to the user.

First a capability of adding and selecting a sub-account after an account is logged in to is set in advance, and after logging into the account, a user may select a sub-account, or may add a new sub-account, for example, add an account “***(a username)”, “Mother”, “Father”, or “I”, or another account, which is not enumerated herein. After a sub-account is selected, a system records a watching history of the user to determine a recommended candidate video for the sub-account and a recommendation level of the recommended candidate video. After the user logs in again and selects the sub-account, the account which the user logs into and the sub-account selected by the user are detected, and at least one recommended candidate video associated with the sub-account is determined, and the at least one recommended candidate video is recommended to the user according to a recommendation level. A video with a higher recommendation level is recommended first.

FIG. 2 is a flowchart illustrating determining a recommended candidate video for each sub-account. As illustrated in FIG. 2, the recommended candidate video is determined by using the following operations: recording and storing a preferred video for the sub-account selected by the user, where each video has one or more category tags; and determining, according to a category tag of the preferred video, a video having the category tag as the recommended candidate video, where the recommended candidate video has at least one category tag the same as at least one category tag of the preferred video.

First all videos are labeled according to categories, where the categories may be “actors”, “video types (sports, entertainment, and the like)”, “video content (award ceremonies, interviews, and the like)”, or the like. After the categorization, each video has at least one category tag. Then a preferred video for the sub-account selected by the user is recorded and stored, where the preferred video includes a video desired by the user, a video repeatedly played by the user, a video commented multiple times by the user, or a video to which the user shows preference in another manner. The preferred video has been labeled, and therefore the preferred video has at least one category tag. Searching is performed according to the category tag of the preferred video to find a video having the same category tag or at least one category tag the same as the preferred video and use the found video as a recommended candidate video. A quantity of same category tags between the recommended candidate video and the preferred video is detected, and a recommendation level is set according to the quantity of same category tags, where a greater quantity of the same category tags indicates a higher recommendation level of the recommended candidate video.

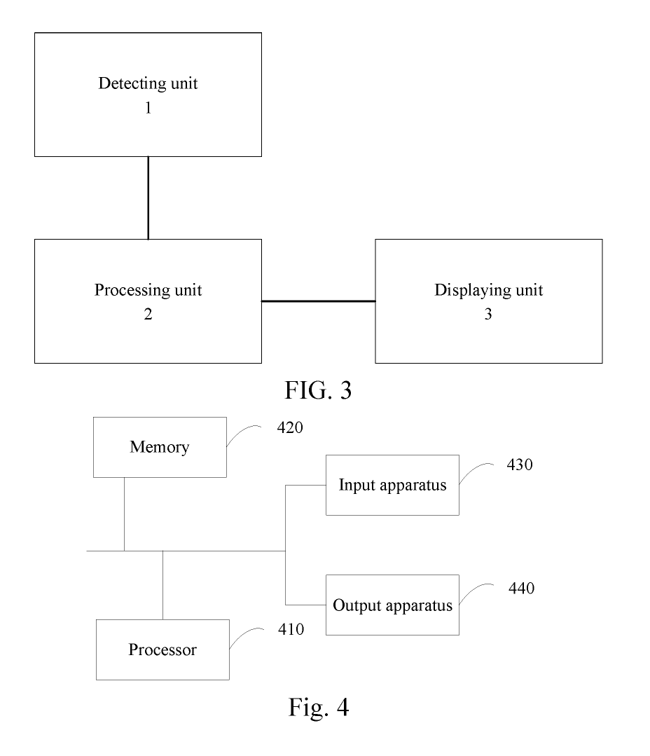

FIG. 3 is a schematic structural diagram illustrating a single-account multiple-preference recommendation apparatus according to an embodiment of the present disclosure. As illustrated in FIG. 3, a single-account multiple-preference recommendation apparatus for a video website includes: a displaying unit 3; a detecting unit 1, configured to detect an account which a user logs into and detect which sub-account the user selects from one or more associated sub-accounts; and a processing unit 2, configured to perform the following operations: controlling the displaying apparatus 3 to display the one or more associated sub-accounts of the account; determining, according to the sub-account selected by the user, a recommended candidate video associated with the sub-account; and selecting a video from the recommended candidate video and pushing the selected video to the user.

The processing unit 2 is further configured to: determine a recommendation level of the recommended candidate video, and preferentially push a recommended candidate video with a higher recommendation level to the user.

After the user logs in and selects a sub-account, the detecting unit 1 detects an account which the user logs into, the processing unit 2 controls the displaying unit 3 to display one or more associated sub-accounts of the account, and waits for the user to select a sub-account, and the processing unit 2 determines a recommended candidate video associated with the sub-account, and pushes the recommended candidate video to the user. A video with a higher recommendation level is recommended first.

The recommended candidate video is determined by using the following operations: recording and storing a preferred video for the sub-account selected by the user, where each video has one or more category tags; and determining, according to a category tag of the preferred video, a video having the category tag as the recommended candidate video, wherein the recommended candidate video has at least one category tag the same as at least one category tag of the preferred video.

After all videos are categorized, each video has at least one category tag. The processing unit 2 records and stores a preferred video for the sub-account selected by the user, where the preferred video may include a video desired by the user, a video repeatedly played by the user, a video commented multiple times by the user, or a video to which the user shows preference in another manner. The preferred video has been labeled, and therefore the preferred video has at least one category tag. The processing unit 2 performs searching according to the category tag of the preferred video to find a video having the same category tag or at least one category tag the same as the preferred video and uses the found video as a recommended candidate video, detects a quantity of same category tags between the recommended candidate video and the preferred video, and sets a recommendation level according to the quantity of same category tags, where a greater quantity of the same category tags indicates a higher recommendation level of the recommended candidate video.

With the above technical solutions, according to the single-account multiple-preference recommendation method for a video website and the single-account multiple-preference recommendation apparatus for a video website provided in the embodiments of the present disclosure, first, an account which a user logs into is detected, and one or more associated sub-accounts of the account are displayed; then, which sub-account the user selects from the one or more associated sub-accounts is detected; a recommended candidate video associated with a selected sub-account is determined according to the selected sub-account; and finally, a video is selected from the recommended candidate video and the selected video is pushed to the user. The single-account multiple-preference recommendation method for a video website provided in the embodiments of the present disclosure greatly improves user experience, and resolves the problem of inaccurate recommendation for single account and multiple users.

An embodiment of the present disclosure further provides a non-volatile computer memory, which stores computer executable instructions, where the computer executable instructions can execute the single-account multiple-preference recommendation method for a video website in any foregoing method embodiment.

FIG. 4 is a schematic structural diagram of hardware of an electronic device for executing the single-account multiple-preference recommendation method for a video website provided in an embodiment of this apparatus. As shown in FIG. 4, the electronic device includes: one or more processors 410 and a memory 420, where only one processor 410 is used as an example in FIG. 4.

The device for executing the single-account multiple-preference recommendation method for a video website may further include: an input apparatus 430 and an output apparatus 440.

The processor 410, the memory 420, the input apparatus 430, and the output apparatus 440 can be connected by means of a bus or in other manners. A connection by means of a bus is used as an example in FIG. 4.

Memory 420 is a non-transitory computer-readable medium for storing a non-transitory software program, a non-transitory computer-readable program and module, for example the program instructions/module for performing an above described method (e.g. Detection apparatus 1, Processing apparatus 2 and displaying apparatus shown in FIG. 3). The processor 410 can operate the various functions and data processing of a server to perform the single-account multiple-preference recommendation method for a video website described in the above embodiments by executing non-transitory software programs, instructions and modules stored in the memory 420.

The memory 420 can include a program storage area and a data storage area. Among them, the program storage area may store operation system, application programs of at least one function; the data storage area may store generated data during operation of the electronic apparatus for performing the method described in the above embodiments. In addition, the memory 420 may include a high speed random access memory, and a non-transitory memory, for example a magnetic storage device (e.g., hard disk, floppy disk, and magnetic strip), a flash memory device (e.g., card, stick, key drive) or other non-transitory solid state storage device. In some embodiments, the memory 420 may include a memory that is remote to the processor 410. The remote memory may be connected to the electronic apparatus for single-account multiple-preference recommendation for a video website by a network. The examples of such as network include but not limited to Internet, enterprise intranet, local area network, mobile telecommunication network and a combination thereof.

The input apparatus 430 can receive input number or byte information, and can generate input key information relating to user setting and functional control of the electronic apparatus for single-account multiple-preference recommendation for a video website described in the above embodiments. The output apparatus 440 may include a display device such as a display screen.

The one or more modules stored in the memory 420 that, when executed by the one or more processors 410, can perform any of the above described method embodiments single-account multiple-preference recommendation method for a video website.

The above products can perform any of the above described methods, and have corresponding functional modules and effects. Details that are not disclosed in this embodiment can be understood by reference to the above method embodiments of the present disclosure.

An electronic apparatus of the present disclosure can exist in a varied form and includes but not limited to:

(1) A mobile communication device which is capable of performing mobile communication function and having a main purpose for audio or data communication. Such a mobile communication device includes: a smart phone (e.g. iPhone), a multimedia phone, a functional mobile phone and a low-end mobile phone etc.

(2) A super-mobile personal computer which belongs to the field of a personal computer and has calculation and processing functions, and in general can access to a mobile network. Such a terminal device includes: a PDA, a MID and a UMPC etc., for example iPad.

(3) A portable entertainment device which is capable of displaying and playing multimedia content. Such a device includes: an audio player, a video player (e.g. iPod), a handheld game console, an electronic book, a smart toy and a portable automotive navigation device.

(4) A server which can provide calculation service and can include a processor, a hard disk, a memory, a system bus etc. Such a server is similar to a general computer in terms of a computer structure, but is necessary to provide reliable service, which therefore requires a higher standard in certain aspects such as data processing, stability, reliability, security and compatibility and manageability etc.

(5) Other electronic apparatus that is capable of data exchange.

The above described apparatus embodiments are for illustrative purpose only, in which modules/units that are described above as separate elements may be physically separate or not separate and modules/units that are described above as display elements may be or may not be a physical unit, i.e. in a same location or in various distributed network units. The skilled person in this field can understand that it is possible to select some or all of the units or modules to achieve the purpose of the embodiment.

According to the above description, the skilled person in this field can understand that various embodiments can be implemented by software over a general hardware platform or by hardware. Accordingly, the above technical solution or what is contributed to the prior art may be implemented in the form of software product. The computer software product may be stored in a computer-readable memory, for example random access memory (RAM), read only memory (ROM), compact disk (CD), digital versatile disk (DVD) etc. which includes instructions for causing a computing device (e.g. a personal computer, a server or a network device etc.) to perform a method of some or all parts of any one of the above described embodiments.

Finally, it should be noted that the previous embodiments are provided to enable any person skilled in the art to practice the various embodiments of the present disclosure described herein but not to limit these aspects. Though the present disclosure is described by reference to the previous embodiments, various modifications and equivalent features will be readily apparent to those skilled in the art without departing from the spirit and scope of the present disclosure, and the generic principles defined herein may be applied to other aspects or with equivalent features. Thus, the claims are not intended to be limited to the aspects and features shown herein, but are to be accorded with the full scope consistent with the language of the claims.

What is claimed is:

1. A single-account multiple-preference recommendation method for a video website, applied to a terminal, comprising:
detecting an account which a user logs into, and displaying one or more associated sub-accounts of the account;
detecting a sub-account the user selects from the one or more associated sub-accounts;
determining, according to the selected sub-account, at least one recommended candidate video associated with the sub-account; and
selecting at least one video from the at least one recommended candidate video and pushing the video selected to the user.

2. The single-account multiple-preference recommendation method for the video website according to claim 1, wherein the selecting at least one video from the at least one recommended candidate video and pushing the video selected to the user comprises: determining a recommendation level of the at least one recommended candidate video, and preferentially pushing a recommended candidate video with a higher recommendation level to the user.

3. The single-account multiple-preference recommendation method for the video website according to claim 1, wherein the at least one recommended candidate video is determined by performing the following operations:
recording and storing at least one preferred video for the sub-account selected by the user, wherein each preferred video has one or more category tags; and
determining, according to the category tags of the at least one preferred video, the at least one video having the category tags as the at least one recommended candidate videos, wherein the at least one recommended candidate video has at least one category tag the same as at least one category tag of the at least one preferred video.

4. The single-account multiple-preference recommendation method for the video website according to claim 3, wherein a greater quantity of the same category tags indicates a higher recommendation level of the at least one recommended candidate video.

5. The single-account multiple-preference recommendation method for the video website according to claim 3, wherein the at least one preferred video comprises one or more of a video desired by the user, a video repeatedly played by the user, or a video commented multiple times by the user.

6. A non-volatile computer memory, which stores computer executable instructions that, when executed by an electronic device, cause the electronic device to:
detect an account into which a user logs, and displaying one or more associated sub-accounts of the account;
detect an sub-account the user selects from the one or more associated sub-accounts;
determine, according to the selected sub-account, at least one recommended candidate video associated with the sub-account; and
select at least one video from the at least one recommended candidate video and pushing the video selected to the user.

7. The non-volatile computer memory according to claim 6, wherein the selecting at least one video from the at least one recommended candidate video and pushing the video selected to the user comprises: determining a recommendation level of the at least one recommended candidate video, and preferentially pushing a recommended candidate video with a higher recommendation level to the user.

8. The non-volatile computer memory according to claim 6, wherein the at least one recommended candidate video is determined by using the following operations:
recording and storing a preferred video for the sub-account selected by the user, wherein each video has one or more category labels; and
determining, according to a category label of the preferred video, a video having the category label as the at least one recommended candidate video, wherein the at least one recommended candidate video has at least one category label the same as at least one category label of the preferred video.

9. The non-volatile computer memory according to claim 8, wherein a greater quantity of the same category labels indicates a higher recommendation level of the recommended candidate video.

10. The non-volatile computer memory according to claim 8, wherein the preferred video comprises one or more of a video liked by the user, a video repeatedly played by the user, or a video commented multiple times by the user.

11. An electronic device, comprising:
at least one processor; and
a memory communicably communication with the at least one processor, wherein
the memory stores instructions executable by the at least one processor, wherein
execution of the instructions by the at least one processor causes the at least one processor to:
detect an account into which a user is logged, and displaying one or more associated sub-accounts of the account;
detect which sub-account the user selects from the one or more associated sub-accounts;
determine, according to the selected sub-account, a recommended candidate video associated with the sub-account; and
select a video from the at least one recommended candidate video and pushing the selected video to the user.

12. The electronic device according to claim 11, wherein the selecting a video from the at least one recommended candidate video and pushing the selected video to the user comprises: determining a recommendation level of the recommended candidate video, and preferentially pushing a recommended candidate video with a higher recommendation level to the user.

13. The electronic device according to claim 11, wherein the at least one recommended candidate video is determined by using the following operations:
recording and storing a preferred video for the sub-account selected by the user, wherein each video has one or more category labels; and
determining, according to a category label of the preferred video, a video having the category label as the at least one recommended candidate video, wherein the at least one recommended candidate video has at least one category label the same as at least one category label of the preferred video.

14. The electronic device according to claim 13, wherein a greater quantity of the same category labels indicates a higher recommendation level of the recommended candidate video.

15. The electronic device according to claim 13, wherein the preferred video comprises one or more of a video liked by the user, a video repeatedly played by the user, or a video commented multiple times by the user.
